(19) United States
(12) Patent Application Publication
(10) Pub. No.: US 2020/0074567 A1
(43) Pub. Date: Mar. 5, 2020

(54) A SYSTEM AND A METHOD FOR DYNAMIC RESUME GENERATION

(71) Applicant: Shawaz SHARIF, BANGALORE (IN)

(72) Inventor: Shawaz SHARIF, BANGALORE (IN)

(21) Appl. No.: 16/604,585

(22) PCT Filed: Jul. 6, 2017
(86) PCT No.: PCT/IB2017/054073

§ 371 Date: Oct. 11, 2019

(30) Foreign Application Priority Data
Apr. 17, 2017 (IN) 201741013482

(51) Int. Cl. G06Q 50/00; H04L 29/08; G06Q 10/10; H04L 12/58; G06F 16/9535

(52) U.S. Cl. CPC G06Q 50/01; H04L 67/306; G06F 16/9535; H04L 51/32; G06Q 10/1053

(57) ABSTRACT

The present invention relates to a system 701 and a method for dynamic resume generation based on user content such as job management, academics, online training, social activity and so on for one or more users. The system 701 for dynamic resume generation includes at least an interface device and an application server. The application server 603 includes a resume generation engine 101 for generating dynamic resume based on the user content. The resume generation engine 101 includes several modules for determining the skill 102 level of the user that includes a job management module 201, an academics module 301, an online training module 401, and a social activity module 501. The application server 603 further includes several modules for allowing the users to the access the system 701 for social networking.

### FIELD OF INVENTION

This description generally relates to the field of networking platforms. More specifically, the invention provides a system and a method for dynamic resume generation based on user content for one or more users.

### BACKGROUND AND PRIOR ART

In recent times, digital devices like smartphones, tablets, laptops and the like have become an integral part of our lives. The availability of these devices has given the users a plethora of communication options such as e-mail, instant messaging, chat rooms, bulletin and discussion boards, file sharing applications, and blogs and other web sites. These and still other communication systems have been proposed for use in “social network platforms” or simply “social platforms”. In general terms, a social network platform or a social platform is a group of persons or other entities that are linked to one another via various forms of social connections. For instance, on a social platform, members can be linked to other members by connections including common friends, place of work, place of education, place of residence, and the like.

Social platform web sites generally allow users to create a profile and link to various other users registered on that particular social platform. Different kinds of social platforms cater to different requirements. See, for example, http://www.facebook.com and http://www.myspace. com. These social platforms allow the users to connect with each other, post messages, share photos, and other user contents. These social platforms even allow the users to connect with long lost friends with whom one might have lost contact over a period of time. Other social platforms, e.g., http://www.linkedin.com have been designed with a view to allow the users expand their professional circle by connecting with other users from the same line of work.

In a country like India, which is abundant with human resource, every year there is a large number of youth that are graduating from universities all over the country. These are the people who have just successfully completed their education and are seeking employment. Typically, these youth have to rely on the Training and Placement cells of their respective universities for getting employed. However, in general, the number opportunities that the Training and Placement cells can provide are not that high.

Therefore, with a view to provide more opportunities and exposure to the freshly graduated youth, there is need of system that allows the users to exhibit their talents to the recruiters while also helping them to collaborate with other registered users to expand their collection of skill-sets.

### OBJECTS OF THE INVENTION

Some of the objects of the present disclosure are described herein below:

A main object of the present invention is to provide a system and a method for generating dynamic resume based on user content for one or more users.

Another object of the present invention is to provide a system for signing up in the platform/system using university/college name.

Still another object of the present invention is to provide a system for allowing the university to invite its members that includes admin, students and faculties.

Yet another object of the present invention is to provide a system for allowing the users to access the platform/system using verified mobile number to retrieve one time password (OTP).

Another object of the present invention is to provide a system for allowing the user to enter in the platform either as an admin, faculty, and student.

Another object of the present invention is to provide a system for allowing the students to access online training

Another object of the present invention is to provide a system for allowing the students to access to employ shop (job management platform).

Another object of the present invention is to provide a system for analyzing the user activities for resume generation.

Another object of the present invention is to provide a system for allowing the user to access activity stream of the users.

Another object of the present invention is to provide a system for allowing the users to follow other users and universities.

Another object of the present invention is to provide a system for allowing the users to post/upload within the platform/system that includes file, project, news, assignment, report and event.

The other objects and advantages of the present invention will be apparent from the following description when read in conjunction with the accompanying drawings, which are incorporated for illustration of preferred embodiments of the present invention and are not intended to limit the scope thereof.

### SUMMARY OF THE INVENTION

In view of the foregoing, an embodiment herein provides a system and a method for generating dynamic resume for one or more users based on user content. The system for dynamic resume generation based on a user content for one or more users comprising a user interface and an application server. The application server includes a resume generation engine. The user interface can be provided for accessing the system. The application server can be configured for providing a social networking platform for the users belongs to a plurality of educational institutes or universities. The resume generation engine can be provided for generating dynamic resume based on the user content. The user content includes details related to job management skill, academics, online training, social activity and so on.

According to an embodiment, the resume generation engine comprises of a job management module, an academics module, an online training module, and a social module. The social module includes but is not limited to sub-modules such as a project module, a media module, an event module and a news module. According to an embodiment, the application server further includes but is not limited to an authentication module, a membership module, a posting module, a notification module, a search module, a social module and a subject module. In addition to that, the application server further includes external connections module and that can be configured for diverting the users to referral systems such as online course, employ shop, city milana and so on.

According to an embodiment, the method for resume generation based on a user content for one or more users on a system comprising the following steps: signing up in the system using university/college name; allowing the university to invite the members/users that includes admins, faculties and students; allowing the users to access the platform using verified mobile number to retrieve one time password (OTP); allowing the user to enter in the platform either as an admin, faculty, and student; allowing the students to access online training; allowing the students to access to the job management platform or employ shop; analyzing the user activities for resume generation; allowing the user to access activity stream of the users; allowing the users to follow other users and universities; and allowing the users to post/upload within the platform that includes file, project, news, assignment, report and event.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a general block diagram for resume generation engine of the system, according to an embodiment herein;

FIG. 2 illustrates a schematic of the job management module in the system illustrated in FIG. 1, according to an embodiment herein;

FIG. 3 illustrates a schematic of the academics module in the system illustrated in FIG. 1, according to an embodiment herein;

FIG. 4 illustrates a schematic of the online training module in the system illustrated in FIG. 1, according to an embodiment herein;

FIG. 5 illustrates a schematic of the social module in the system illustrated in FIG. 1, according to an embodiment herein;

FIG. 6 illustrates a schematic layout of a system for dynamic resume generation, according to an embodiment herein; and

FIG. 7 illustrates the steps involved in a method for dynamic resume generation, according to an embodiment herein.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

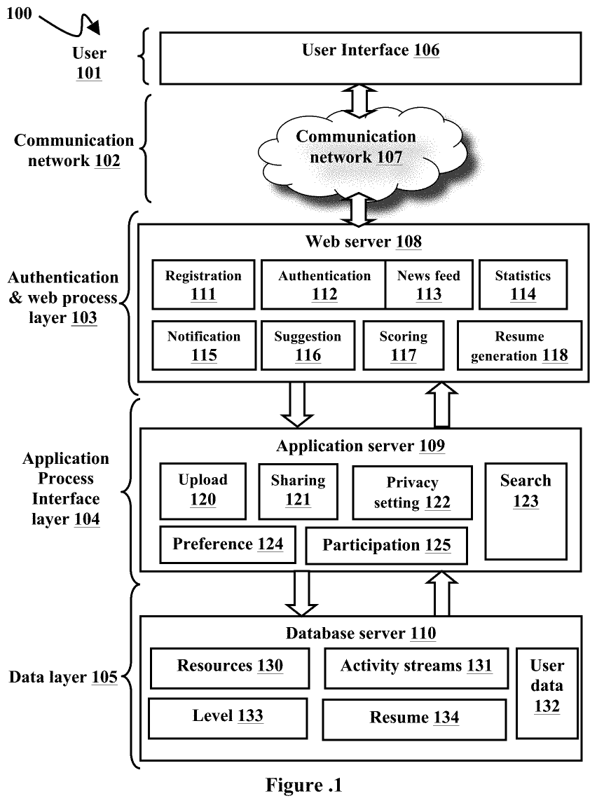

As mentioned above, there is a need a system to generate dynamic resume based on the user content for one or more users. The embodiments herein achieve this by providing a system and a method for generating dynamic resume based on the user content such as job management, academics, online training, social activity and so on for one or more users. Referring now to the drawings, and more particularly to FIGS. 1 through 7, where similar reference characters denote corresponding features consistently throughout the figures, there are shown preferred embodiments.

It should be noted that the term “layout” only refers to a general structure of the system and is only meant to provide a gist of the system. The term “layer”, as used in the present specification is synonymous with stage. As such, FIG. 1 is meant to provide an introduction of the system and is not to construed as limiting in any manner. Referring to FIG. 1, illustrates a general block diagram 100 for resume generation engine 101 of the system. According to an embodiment, the resume generation engine 101 can generate the resume based on the user content of one or more users. According to the user content, the user's skill level 102 is assessed. The user content for the skill 102 assessment of the user 601 (shown in FIG. 6) includes a job management 103, academics 104, online training 105 and social activity 106.

According to an embodiment, from the job management 103 skill is analyzed by certain criteria such as jobs completed 107 by the user, jobs that are in progress 108, jobs allotted 109 for the user, and the employ rating 110 or appraisal given for the user. From users academics skill 102 is determined from the results 111, class project 112, assignments 113, attendance 114 and so on. Further, the users' skill 102 also determined from then online training 105 that may be a certified course 115, paid course 116, free course 117 and so on. The users' skill 102 is also assessed from the social activity 106 such as projects 118, events 119, news 123, media 125 and so on. In the events 119, the criteria's that is considered are invitation 120 for participation in an event, comments 121, trophy 122 or rewards received by the user and so on. Similarly for news 123, the criterion that is considered is the comments 124 provided by the user. Further, in the media 125, the criteria that are considered are the post that are shared 126 by the users, likes 127 and comments 128 posted by other users for the users postings.

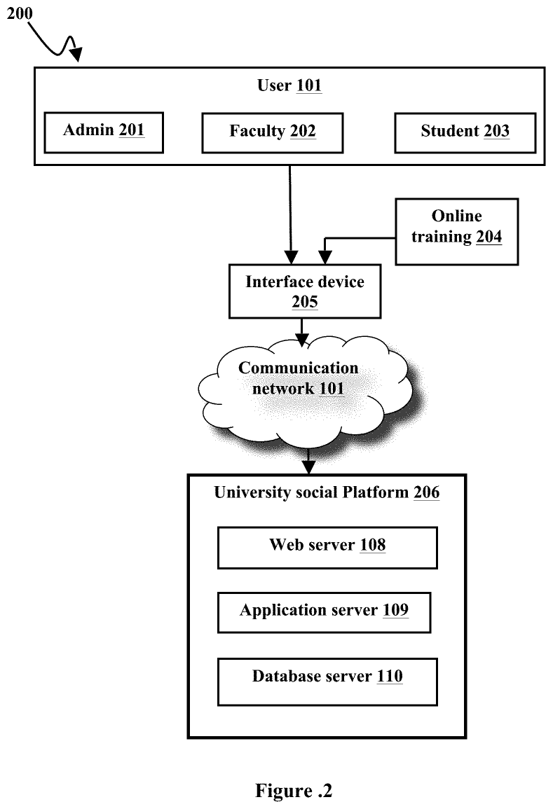

FIG. 2 illustrates a schematic 200 of the job management module 201 in the system 701 illustrated in FIG. 1, according to an embodiment. According to an embodiment, the resume generation engine 101 includes several modules for determining the skill 102 level of the user that includes a job management module 201, an academics module 301, an online training module 401, and a social activity module 501. The job management module 201 can be configured for allowing a plurality of employer or job poster to post a job 202 from employer shop. Further, the job management module 201 can be configured for allowing a student to retrieve a notification 203 for the job post and to apply 204 for a job. The job management module 201 can be further configured for allowing the employer or job poster to review 205 the application 204 for the job by the student and to send a job offer 206 to the student. In addition to that, the job management module can be further configured for allowing the student to accept or decline 207 the job offer and to start 208 the job after acceptance. The job management module 201 can be further configured for providing a predetermined ratio (For example 1:1) of a skill 102 level in job management 103 of the user for generating the dynamic resume. The priority is higher compared to all other skills 102.

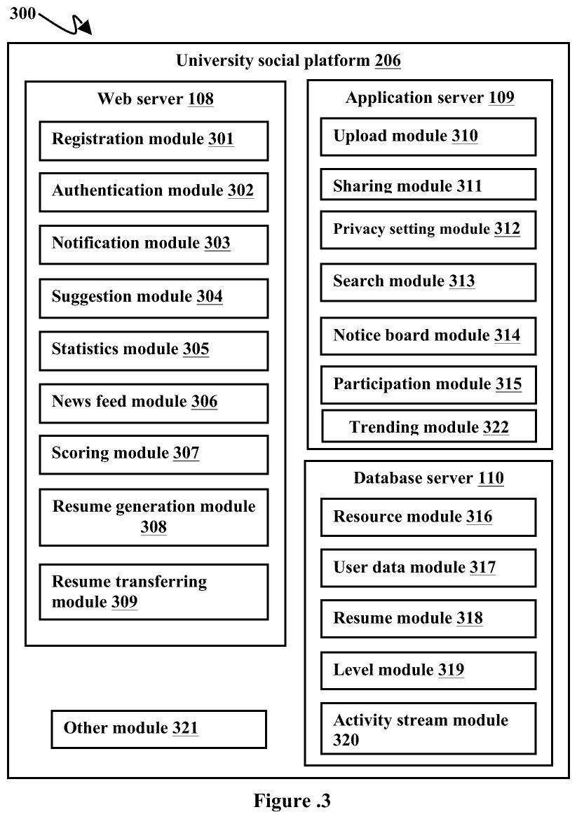

FIG. 3 illustrates a schematic 300 of the academics module 301 in the system 701 illustrated in FIG. 1, according to an embodiment. The academics module 301 can be configured for updating attendance 114, assignment 113 details, class subjects 112 and results 111 for all students, enrolled in the system 701. Further, the academics module 301 can be configured for providing a predetermined ratio (For example 1:01) of a skill 102 level in academics of the user for generating the dynamic resume. The priority is lesser compared to the job management skill 103.

FIG. 4 illustrates a schematic 400 of the online training module 401 in the system 701 illustrated in FIG. 1, according to an embodiment. The online training module 401 can be configured for suggesting courses such as certified course 115, paid course 116, free course 117 and so on for the student's career development. Further, the online training module 401 can be configured for allowing the student to undergo training in the suggested course and update the results in the system 701 after completion of the course. The online training module 401 can be further configured for providing a predetermined ratio (For example 1:001) of a skill 102 level in online training of the user for generating the dynamic resume. The priority is little lesser compared to the academic skill 102.

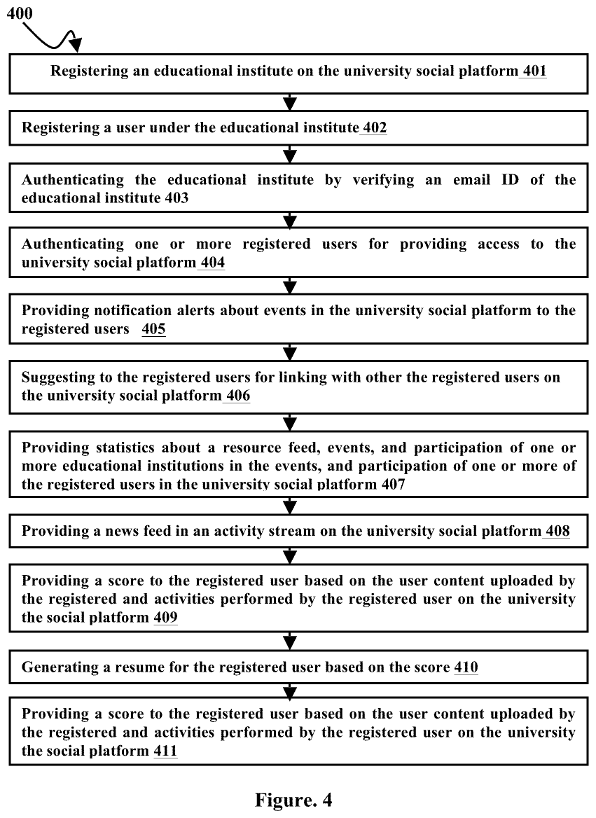

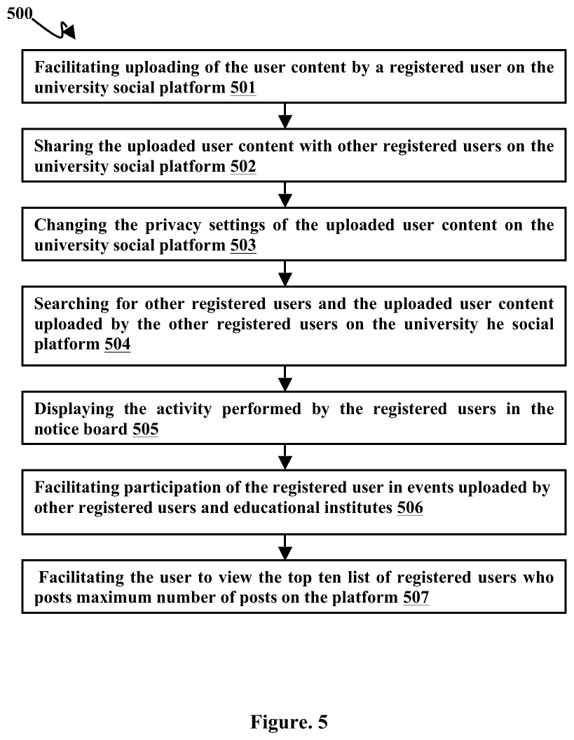

FIG. 5 illustrates a schematic 500 of the social module 501 in the system 701 illustrated in FIG. 1, according to an embodiment. The social module 501 includes but is not limited to sub-modules such as a project module 502, a media module 503, an event module 504 and a news module 505. The project module 502 can be configured for allowing the user to provide details about a personal project and a college projects. The media module 503 can be configured for allowing the user to share 126, like 127 and/or comment 128 on media files that are uploaded by one or more users. Even the user's activity in media that is posted either by him or other users is also considered for assessing the skill 102 of the user. The event module 505 can be configured for allowing the user to invite 120 other users on the system 701 and to announce a trophy 122 or comment 121. The news module 505 can be further configured for allowing the user to post news and to give comments 124 for the news posted by other users. The social module 501 can be further configured for providing a predetermined ratio (For example 1:0001) of a skill 102 level in social activity of the user for generating the dynamic resume.

FIG. 6 illustrates a schematic layout 600 of a system 701 for dynamic resume generation, according to an embodiment. According to an embodiment, the schematic layout of the system 701 includes a user 601, a plurality of interface devices 602 and an application server 603 (RESTFUL API). The application server 603 further includes but is not limited to an authentication module 605, a membership module 606, a posting module 607, a notification module 608, a search module 609, a social module 610, a subject module 611, a resume generation engine 101 and a plurality of external connections 604.

According to an embodiment, the authentication module 605 can be configured for authenticating the educational institute by verifying an email ID of the educational institute and also through phone by means of one time password (OTP) 612. The authentication module 605 can be further configured for authenticating one or more registered users for providing access to the system 701. According to an embodiment, the membership module 606 can be configured for facilitating registration of an educational institute on the system 701. The membership module 606 can be further configured to facilitate registration of the user either as a college admin 613 or faculty 614 or student under the educational institute on the system 701.

According to an embodiment, the posting module 607 can be configured for posting or uploading a file 615, projects 616, assignments 617, reports 618 and news 619. The notification module 608 can be configured to provide notification alerts about assignments 620, reports 621, posts 622, follow 623, job offer 624 and so on in the system 701. The search module 609 can be configured to facilitate searching for people 625 and/or college/university 626 and/or posts 627 that are uploaded by said other users on the system 701.

According to an embodiment, the social module 610 can be configured for allowing user to perform activities like follow 628, bookmark 630, comment 631, like 628 and so on. The subject module 611 can be configured for allowing users to upload lectures 632 related to the subject, assignments 633 and reports 634 for the subject. According to an embodiment, the application server 603 further includes external connections module 604 can be configured for diverting the users to referral systems 701 such as online course 636, employ shop 635, city milana 637 and so on. According to an embodiment, the resume generation engine 101 can generate the resume based on the user content of one or more users 601. According to the user content, the user's skill level 102 is assessed. The user content for the skill 102 assessment of the user includes a job management 103, academics 104, online training 105 and social activity 106.

Exemplary methods for implementing a system 701 for dynamic resume generation based on the user content for one or more users are described with reference to FIG. 7. These exemplary methods can be described in the general context of computer executable instructions. Generally, computer executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network. In a distributed computing environment, computer executable instructions may be located both in local and remote computer storage media, including memory storage devices.

The exemplary methods are illustrated as a collection of operations in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be deleted from the methods without departing from the spirit and scope of the subject matter described herein. In the context of software, the operations represent computer instructions that, when executed by one or more processors, perform the recited operations.

FIG. 7 illustrates the steps involved in a method 700 for dynamic resume generation, according to an embodiment. According to an embodiment, the method for resume generation based on a user content for one or more users on a system/university social platform 701 comprising the following steps of: signing up in the system 701 using university/college name 702; allowing the university to invite the members/users that includes admins, faculties and students 703; allowing the users to access the platform using verified mobile number to retrieve one time password (OTP) 704; allowing the user to enter in the platform either as an admin, faculty, and student 705; allowing the students to access online training 706; allowing the students to access to the job management platform 201 or employ shop 707; analyzing the user activities for resume generation; allowing the user to access activity stream of the users 708; allowing the users to follow other users and universities 709; and allowing the users to post/upload within the platform that includes file, project, news, assignment, report and event 710.

According to an embodiment, all the users of the system 701 can get the rights to post files within the system 701. Further, the projects can be posted by admin and students. The news can be posted by the admin and that news can be related to any event or notice to the student, job offer, placement training and so on. The assignment can be posted by the faculty for the student. The performance report of the student can be posted by the faculty. The event notification can be posted by the admin for the student.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A system (701) for dynamic resume generation based on a user content for one or more users, said system (701) comprising:
a user (601) interface provided for accessing the system (701);
characterized in that
an application server (603) configured for providing a social networking platform for the users (601) belongs to a plurality of educational institutes or universities;
wherein the application server (603) includes a resume generation engine 101 for generating dynamic resume based on the user content; and
wherein the user content includes details related to job management skill (103), academics (104), online training (105), social activity (106) and so on.

2. The system as claimed in claim 1, wherein the resume generation engine 101 comprises of a job management module (201), an academics module (301), an online training module (401), and a social module (501).

3. The system as claimed in claim 1, wherein the job management module (201) configured for allowing a plurality of employer or job poster to post a job (202) from employer shop; wherein the job management module (201) further configured for allowing a student to retrieve a notification (203) for the job post and to apply (204) for a job.

4. The system as claimed in claim 1, wherein the job management module (201) further configured for allowing the employer or job poster to review (205) the application for the job by the student and to send a job offer (206) to the student.

5. The system as claimed in claim 1, wherein the job management module (201) further configured for allowing the student to accept or decline (207) the job offer and to start (208) the job after acceptance; and wherein the job management module (201) further configured for providing a predetermined ratio of a skill (102) level in job management (103) of the user for generating the dynamic resume.

6. The system as claimed in claim 1, wherein the academics module (301) configured for updating attendance (114), assignment (113) details, class subjects (112) and results (111) for all students enrolled in the system 701; and wherein the academics module (301) further configured for providing a predetermined ratio of a skill (102) level in academics of the user for generating the dynamic resume.

7. The system as claimed in claim 1, wherein the online training module (401) configured for suggesting courses such as certified course (115), paid course (116), free course (117) and so on for the student's career development; and wherein the online training module (401) further configured for allowing the student to undergo training in the suggested course and update the results after completion of the course.

8. The system as claimed in claim 1, wherein the online training module (401) further configured for providing a predetermined ratio of a skill level (102) in online training (105) of the user for generating the dynamic resume.

9. The system as claimed in claim 1, wherein the social module (501) includes sub-modules such as a project module (502), a media module (503), an event module (505) and a news module (504);
wherein the project module (502) configured for allowing the user to provide details about a personal project and college projects;
wherein the media module (503) configured for allowing the user to share (126), like (127) and/or comment (128) on a media files uploaded by one or more users;
wherein the event module (505) configured for allowing the user to invite (120) other users on the system (701) and to announce a trophy (122) or comment (122);
wherein the news module (504) can be further configured for allowing the user to post news and to give comments (124) for the news posted by other users; and
wherein the social module (501) further configured for providing a predetermined ratio of a skill level (102) in social activity (106) of the user for generating the dynamic resume.

10. The system as claimed in claim 1, wherein the application server (603) further includes an authentication module (605), a membership module (606), a posting module (607), a notification module (608), a search module (609), a social module (610) and a subject module (611).

11. The system as claimed in claim 10, wherein the authentication module (605) configured to authenticate said educational institute by verifying an email ID of said educational institute and also through phone by means of one time password (OTP) (612); and wherein said authentication module (605) further configured to authenticate one or more registered users for providing access to said system (701).

12. The system as claimed in claim 10, wherein the membership module (606) configured to facilitate registration of an educational institute on said system 701;
and wherein said membership module (606) further configured to facilitate registration of said user either as a college admin (613) or faculty (614) or student under the educational institute on the system (701);
wherein the posting module (607) configured for posting or uploading a file (615), projects (616), assignments (617), reports (618) and news (619); and
wherein the notification module (608) configured to provide notification alerts about assignments (620), reports (621), posts (622), follow (623), job offer (624) and so on in the system (701).

13. The system as claimed in claim 10, wherein the search module (609) configured to facilitate searching for people (625) and/or college/university (626) and/or posts (627) that are uploaded by said other registered users on said system (701);
wherein the social module (610) configured for allowing user to perform activities like follow (628), bookmark (630), comment (631), like (629)and so on; and
wherein the subject module (611) configured for allowing users to upload lectures (632) related to the subject, assignments (633) and reports (634) for the subject.

14. The system as claimed in claim 1, wherein the application server (603) further includes external connections module (604) configured for diverting the users to referral systems such as online course (636), employ shop (635), city milana (637) and so on.

15. A method for resume generation based on a user content for one or more users on a system (701) comprising the following steps:
signing up in the system (701) using university/college name (702);
allowing the university to invite the members/users that includes admins, faculties and students (703);
allowing the users to access the platform using verified mobile number to retrieve one time password (OTP) (704);
allowing the user to enter in the platform either as an admin, faculty, and student (705);
allowing the students to access online training (706);
allowing the students to access to the job management platform 201 or employ shop (707);
analyzing the user activities for resume generation (708);
allowing the user to access activity stream of the users (709);
allowing the users to follow other users and universities (710); and
allowing the users to post/upload within the platform that includes file, project, news, assignment, report and event (711).
